(19) United States
(12) Patent Application Publication
(10) Pub. No.: US 2026/0210495 A1
(43) Pub. Date: Jul. 23, 2026

(54) MULTILAYER STRUCTURE AND ARTICLES FOR THE STORAGE AND TRANSPORTATION OF GASSES

(71) Applicant: Solvay Specialty Polymers USA, LLC, Alpharetta, GA (US)

(72) Inventors: Florence Clement, Yzeron (FR); Yves Vanderveken, Leuven (BE); Stéphane Jeol, Saint-Genis-Laval (FR); Didier Delimoy, Chaumont-Gistoux (BE); Glenn P. Desio, Marietta, GA (US); Véronique Bossennec, Serezin-Durhone (FR)

(73) Assignee: Solvay Specialty Polymers USA, LLC, Alpharetta, GA (US)

(21) Appl. No.: 19/139,800

(22) PCT Filed: Dec. 12, 2023
(86) PCT No.: PCT/EP2023/085327

§ 371 Date: Jun. 16, 2025

Related U.S. Application Data
(60) Provisional application No. 63/387,308, filed on Dec. 14, 2022.

(30) Foreign Application Priority Data
Feb. 27, 2023 (EP) 23158669.4

(51) Int. Cl. F17C 1/16; B32B 1/08; B32B 27/08; B32B 27/34

(52) U.S. Cl. CPC F17C 1/16; B32B 1/08; B32B 27/08; B32B 27/34; B32B 2250/02; B32B 2260/021; B32B 2260/046; B32B 2262/106; B32B 2307/7375; B32B 2597/00; B32B 2605/00; F17C 2203/0604; F17C 2203/0673; F17C 2203/0675; F17C 2221/012; F17C 2260/011; F17C 2260/036

(57) ABSTRACT

A multilayer structure suitable for the manufacture of vessels, in particular pressure vessels, for the storage and transportation of gasses. The vessel is particularly adapted for the storage and transportation of compressed gasses in vehicles.

### REFERENCE TO RELATED APPLICATIONS

This application claims priority to U.S. provisional application No. 63/387,308—filed Dec. 14, 2022—and to European patent application No. 23158669.4—filed Feb. 27, 2023—, the whole content of each of these applications being incorporated herein by reference for all purposes.

### TECHNICAL FIELD

The invention relates to a multilayer structure suitable for the manufacture of articles adapted for the storage and transportation of gasses, in particular of pressure vessels. The invention further relates to the articles, such as pressure vessels, comprising the multilayer structure. The invention further relates to a method for manufacturing a pressure vessel.

### BACKGROUND ART

Pressure vessels characterized by high gas barrier properties have been used for storing various gasses such as oxygen, carbon dioxide, nitrogen, argon, LPG (liquefied petroleum gas), methane, hydrogen, over a long period of time. Pressure vessels comprising a non-structural liner surrounded with a structural fiber reinforced composite material for containing the fluid or gas under pressure are known. The liner acts as a barrier between the fluid or gas and the fiber reinforced composite material, thus preventing leaks and/or other degradations of the structure of the fiber reinforced composite material. The use of structural fiber reinforced composite materials comprising a thermoplastic polymer matrix rather than a thermoset one, is advantageous to facilitate recycling of the pressure vessel.

Pressure vessels comprising a polyamide-based liner and an outer layer which is a composite material that contains a continuous fiber and a polyamide resin impregnated into the continuous fiber are disclosed for instance in EP3225888 A1, EP3390016 A1, and WO21152254 A1.

However the need still exists to develop articles, like pressure vessels for the stored gas and mechanical properties.

The objective of the invention is thus providing multilayer structures combining low permeability to gasses, such as hydrogen, and good mechanical properties. The objective is achieved by the multilayer structure of the invention.

### SUMMARY OF INVENTION

A first object of the invention is thus a multilayer structure comprising at least one barrier layer, [Layer (BL)], and at least one composite layer, [Layer (CL)] in contact with the at least one barrier layer wherein:
Layer (BL) comprises a polyamide polymer PA1; and
Layer (CL) comprises continuous reinforcing fibers and a polyamide polymer PA2,
wherein: polyamide polymer PA1 is selected from the group consisting of the polyamides comprising recurring units deriving from the polycondensation of i) caprolactam; and/or ii) at least one diamine component having 4 to 8 carbon atoms and at least one dicarboxylic acid component having 8 carbon atoms or less;
polyamide polymer PA2 is selected from the group consisting of the polyamides consisting of recurring units deriving from the polycondensation of at least one diamine component, the diamine component having at least 9 carbon atoms, at least one aromatic dicarboxylic acid component and optionally one or more components selected from the group consisting of lactams, aminoacids and aliphatic dicarboxylic acids.

A second object of the invention is an article for storing or transporting a gas comprising the multilayer structure of the first object. Layer (BL) represents the internal layer of the article which is in contact with the gas being stored or transported, hereinafter also referred to as “internal layer” or “liner”, while Layer (CL) represents the external layer of the article. The article may be a vessel, preferably a pressure vessel, that is a vessel for the storage of a gas under pressure.

A third object of the invention is a compressed gas in a vessel comprising the multilayer structure of the first object, wherein layer (BL) is in contact with the compressed gas. Further objects of the invention are a method fo making the vessel as well as the use of the vessel in vehicles.

### DESCRIPTION OF INVENTION

In the present application:
any description, even though described in relation to a specific embodiment, is applicable to and interchangeable with other embodiments of the present disclosure;
where an element or component is said to be included in and/or selected from a list of recited elements or components, it should be understood that in related embodiments explicitly contemplated here, the element or component can also be any one of the individual recited elements or components, or can also be selected from a group consisting of any two of more of the explicitly listed elements or components; any element or component recited in a list of elements or components may be omitted from such list;
any recitation herein of numerical ranges by endpoints includes all numbers subsumed within the recited ranges as well as the endpoints of the range and equivalents;
the indeterminate article “a” in an expression like “a polyamide polymer”, is intended to mean “one or more”, or “at least one” unless indicated otherwise; and
the use of brackets “( )” before and after names of compounds, symbols or numbers, e.g. “Layer (BL)”, “Layer (CL)”, etc . . . , has the mere purpose of better distinguishing that name, symbol or number from the rest of the text; thus, said parentheses could also be omitted.

Unless specifically expressed otherwise, the term “alkyl”, as well as derivative terms such as “alkoxy”, “acyl” and “alkylthio”, as used herein, include within their scope straight chain, branched chain and cyclic moieties. Examples of alkyl groups are methyl, ethyl, 1 methylethyl, propyl, 1,1 dimethylethyl, and cyclo-propyl. Unless specifically stated otherwise, each alkyl and aryl group may be unsubstituted or substituted with one or more substituents selected from but not limited to halogen, hydroxy, sulfo, C1-C6 alkoxy, C1-C6 alkylthio, C1-C6 acyl, formyl, cvano, sterically compatible and the rules of chemical bonding and strain energy are satisfied. The term “halogen” or “halo” includes fluorine, chlorine, bromine and iodine, with fluorine being preferred.

The term “aryl” refers to a phenyl, indanyl or naphthyl group. The aryl group may comprise one or more alkyl groups, and are called sometimes in this case “alkylaryl”; for example may be composed of a cycloaromatic group and two C1-C6 groups (e.g. methyl or ethyl). The aryl group may also comprise one or more heteroatoms, e.g. N, O or S, and are sometimes called “heteroaryl” groups; these heteroaromatic rings may be fused to other aromatic systems.

A first object of the invention is a multilayer structure comprising at least one barrier layer, [Layer (BL)], and at least one composite layer, [Layer (CL)], in contact with the at least one barrier layer as defined in the appended claims.

### Layer (BL)

Layer (BL) is formulated to provide the barrier to permeation of gasses.

Layer (BL) comprises at least one polyamide polymer PA1, hereinafter referred to as “polyamide PA1”.

Polyamide PA1 is selected from the group consisting of the polyamides comprising recurring units deriving from the polycondensation of:
i) caprolactam; and/or alternatively
ii) at least one diamine component having 4 to 8 carbon atoms and at least one dicarboxylic acid component having 8 carbon atoms or less.

Polyamides comprising recurring units deriving from the polycondensation of caprolactam are known and are commonly referred to as PA6.

When polyamide PA1 is formed from the polycondensation of a diamine component and a dicarboxylic acid component, the amount of —NH₂ groups from the diamine component and the amount of —COOH groups from the dicarboxylic acid component are substantially equimolar. The ratio amine/acid can be from 0.9 to 1.1, preferentially from 0.95 to 1.05, even more preferentially from 0.98 to 1.02.

The diamine component may be either aliphatic, cycloaliphatic or aromatic

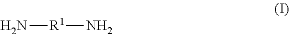

where R¹ is a C4-C8 aliphatic or cycloaliphatic alkylene group which may be linear or branched. Among linear or branched alkylene groups, C4-C6 linear alkylene groups are preferred. Among suitable cycloaliphatic alkylene groups mention may be made of 1,3-bis(aminomethyl)cyclohexane (“1,3-BAC”) and 1,4-bis(aminomethyl)cyclohexane (“1,4-BAC”). Preferably, the bis(aminoalkyl)cyclohexane is 1,3-bis(aminomethyl)cyclohexane.

The bis(aminoalkyl)cyclohexane can be in a cis or trans conformation. Accordingly, the diamine component can include only the cis-bis(aminoalkyl)cyclohexane, only the trans-bis(aminoalkyl)cyclohexane. The bis(aminoalkyl)cyclohexane can be a mixture of cis- and trans-bis(aminoalkyl)cyclohexane. The cis/trans ratio may be between 10/90 an 90/10, preferentially between 20/80 and 80/20 and even more preferentially between 30/70 and 70/30. In some embodiments, the cis/trans ratio is between 50/50 and 68/32.

The diamine component may be aromatic. Examples of suitable C6-C8 aromatic diamines include, but are not limited to, m-phenylene diamine (MPD), p-phenylene diamine (PPD), p-xylylene diamine (PXD) and m-xylylenediamine (MXD).

The dicarboxylic acid component may be either aliphatic, cycloaliphatic or aromatic. Notable non limiting examples of suitable aliphatic dicarboxylic acids are those of formula (II)

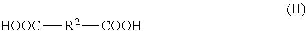

where R² is a C1-C6 aliphatic or cycloaliphatic alkylene group which may be linear or branched. Among linear or branched alkylene groups, C4-C6 linear alkylene groups are preferred. Among suitable cycloaliphatic alkylene groups, mention may be made of 1,4-cyclohexanedicarboxylic acid, tetrahydrofuran-2,5-dicarboxylic acid.

Notable non limiting examples of suitable aromatic dicarboxylic acids are for instance phthalic acids, in particular terephthalic acid (T) and isophthalic acid (I).

Polyamide PA1 can be a copolyamide, that is it may derive from the polycondensation reaction of one or more than one lactam or aminoacid and/or one or more diamine component and/or one or more dicarboxylic acid component.

Typically, polyamide PA1 has a C/NHCO ratio of 6.5 or less, preferably equal to or less than 6.0. The C/NHCO ratio is the average number of carbon atoms between adjacent amide groups per amide group in the polyamide polymer. The average number of carbon atoms between adjacent amide groups is calculated as the average of the carbon atoms in each caprolactam, aminoacid, diamine or dicarboxylic acid component in the polymer weighted by the molar amount of each component in the polymer.

Polyamide PA1 may conveniently be selected from the group consisting of PA6, PA46, PA56, PA MXD6, PA PXD6, PA MXD6/MXDI, PA MXD6/PXD6.

In an advantageous embodiment polyamide PA1 is characterized by a melting temperature of 180 to 300° C. Melting temperature is typically measured at 2^{nd} heat scan by Differential Scanning calorimetry (DSC) according to ASTM D3418 using a heating and cooling rate of 20° C./min.

Layer (BL) does not contain any continuous reinforcing fiber.

Layer (BL) has a thickness which provides the required value of gas permeation required for the application. Layer (BL) typically has a thickness of at least 100 microns, generally at least 250 microns. Layer (BL) may have a thickness of up to 10.0 mm, even 8.5 mm, 7.5 mm. Layer (BL) may have a thickness of 100 microns to 10.0 mm, generally from 250 microns to 10.0 mm, even from 300 microns to 8.5 mm, still from 500 microns to 6.0 mm.

Layer (BL) may comprise one or more than one polyamide PA1.

In a first embodiment, the sole polymeric component in Layer (BL) is a polyamide PA1.

In such an embodiment, Layer (BL) comprises 75.0 wt % or more of the polyamide PA1, even 80.0 wt % or more, still 85.0 wt % or more with respect to the total weight of layer (BL). In such an embodiment layer employed in the formulation of polyamide polymers. Non limiting examples of suitable additives are antioxidants (e.g. ultraviolet light stabilizers and heat stabilizers), impact modifier, chain extender, processing aids, nucleating agents, lubricants, flame retardants, smoke-suppressing agents, anti-static agents, anti-blocking agents, colorants, and pigments.

The total amount of additives may be 20.0 wt % or less, even 10.0 wt % or less with respect to the total weight of Layer (BL). When present, the one or more additives is at least 0.5 wt %, at least 1.0 wt %, in some instances even at least 2.0 wt %, relative to the total weight of the polyamide polymer.

In a second embodiment, Layer (BL) comprises a polyamide PA1 and a least one other thermoplastic polymer different from polyamide PA1.

In an advantageous aspect of said embodiment, Layer (BL) comprises a polyamide PA1 and an impact modifier.

Suitable impact modifiers are for instance functionalized polyolefins with a glass transition temperature lower than 25° C.

The polymer backbone of the impact modifier can be selected from elastomeric backbones comprising polyethylenes and copolymers thereof e.g. ethylene-butene; ethylene-octene; polypropylenes and copolymers thereof; polybutenes; polyisoprenes; ethylene-propylene-rubbers (EPR) ethylene-propylene-diene monomer rubbers (EPDM); ethylene-acrylate rubbers; butadiene-acrylonitrile rubbers, ethylene-acrylic acid (EAA) ethylene-vinylacetate (EVA); acrylonitrile-butadiene-styrene rubbers (ABS) block copolymers styrene ethylene butadiene styrene (SEBS); bloc copolymers styrene butadiene styrene (SBS); core shell elastomers of methacrylate-butadiene-styrene (MBS) type, or mixture of one or more of the above.

When the impact modifier is functionalized, the functionalization of the backbone can result from the copolymerization of monomers which include the functionalization or from the grafting of the polymer backbone with a further component.

Specific examples of functionalized impact modifiers are notably terpolymers of ethylene, acrylic ester and glycidyl methacrylate, copolymers acrylate and glycidyl methacrylate; ethylene-maleic anhydride copolymers EPR grafted with maleic anhydride; styrene copolymers grafted with maleic anhydride; SEBS copolymers grafted with maleic anhydride; styrene acrylonitrile copolymers grafted with maleic anhydride; ABS copolymers grafted with maleic anhydride.

Functionalized polyolefin impact modifiers are available from commercia sources, including maleated polypropylenes and ethylene-propylene copolymers available as Exxelor® PO and maleic anhydride-functionalizes ethylene-propylene copolymer rubber comprising about 0.6 weight percent pendant succinic anhydride groups, such as Exxelor® VA 1801 from the ExxonMobil Chemical Company; acrylate-modified polyethylenes available as Surlyn®, such as Surlyn® 9920, acrylic or methacrylic acid-modifier polyethylene from Dow Inc.; maleic anhydride-modified SEBS bloc copolymer, such as Kraton® FG1901X, a SEBS that has been grafted with about 2 wt % maleic anhydride, available from Kraton Polymers; maleic anhydride-functionalized EPDM terpolymer rubber, such as Royaltuf® 498 a 1% maleic anhydride functionalized EPDM, available from the SI Group.

Other desirable functionalized impact modifiers include, but are not limited to, ethylene-higher alpha-olefin polymers and ethylene-higher alpha-olefin diene polymers grafted or copolymerized with reactive carboxylic acids of their derivatives such as, for example, acrylic acid, methacrylic acid, maleic anhydride or their esters. Suitable higher alpha-olefins include, but are no limited to, C3 to C8 alpha-olefins such as, for example, propylene, 1-butene 1-hexene and styrene.

Among reactive impact modifiers mention may be made of a random terpolymer of ethylene, acrylic ester and glycidyl methacrylate which is commercially available from Arkema (Bristol, PA, USA) under the trade name Lotader® AX8900. Another example of the aforementioned reactive impact modifier is commercially available from Dow Inc. (Midland, MI, USA under the trade name Paraloid™ EXL 2314, which is a core-shell type acrylate based impact modifier comprised of a core primarily comprised of cross-linked poly(n-butyl acrylate) rubber and having a shell phase comprised primarily of a poly(methyl methacrylate)-poly(glycidyl).

In said second embodiment, Layer (BL) comprises from 1.0 wt % to 25.0 wt % of the at least one thermoplastic polymer and/or impact modifier with respect to the total weight of the Layer (BL). The impact modifier can be a least 2.0 wt % or at least 3.0 wt %, even at least 5.0 wt % of the total weigh of Layer (BL). The impact modifier typically is not more than 20.0 wt %, no more than 15.0 wt %, not more than 12.0 wt %, even not more than 10.0 wt % Suitable ranges may be for instance from 1.0 to 15.0 wt %, even from 1.0 to 12.0 wt %, or even 2.0 to 10.0 wt %.

In the second embodiment Layer (BL) may additionally comprise additives as detailed above. The total amount of additives may be 20.0 wt % or less even 10.0 wt % or less with respect to the total weight of Layer (BL) and/or at least 1.0 wt %, even at least 2.0 wt % with respect to the total weight of Layer (BL).

Layer (BL) may be prepared using common techniques for the manufacture of films or sheets of polyamide polymers, as known to the person skilled in the art. For instance, Layer (BL) may be produced by rotomoulding, injection molding and optionally welding, pipe extrusion and extrusion blow molding. The films may be optionally monoaxially or biaxially oriented Biaxial orientation may be performed on tenterframe biaxial orientation equipment as known in the art.

When more than one Layer (BL) is present in the multilayer structure of the invention, each Layer (BL) may comprise the same or a different polyamide PA1, preferably the same polyamide PA1.

### Layer (CL)

The multilayer structure of the invention comprises at least one Layer (CL) Layer (CL) comprises continuous reinforcing fibers and a polyamide polymer PA2, hereinafter referred to as “polyamide PA2”.

Polyamide PA2 is selected from the group consisting of the polyamide consisting of recurring units deriving from the polycondensation of at least one diamine component, the diamine component having at least 9 carbon atoms, at least one aromatic dicarboxylic acid component and optionally one or more components selected from the group consisting of lactams aminoacids and aliphatic dicarboxylic acids.

The diamine component may be either aliphatic, cycloaliphatic or aromatic Notable non limiting examples of suitable aliphatic or cycloaliphatic diamines are those of formula (III):

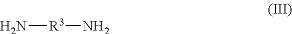

where R³ is a C9-C20 aliphatic or cycloaliphatic alkylene group which may be linear or branched. Among linear or branched alkylene groups, linear or branched C9-C16 alkylene groups are preferred, linear or branched C9-C12 alkylene groups are even more preferred. Notable non limiting examples include 1,9-nonanediamine, 2-methyl-1,8-octanediamine (Me8) 1,10-decanediamine, 1,12-dodecanediamine, 1,13-tridecanediamine, 2,2,4-trimethyl-1,6-hexanediamine or 2,4,4-trimethyl-1,6-hexanediamine (TMD isomers), 5-methyl-1,9-nonanediamine. Among suitable cycloaliphatic alkylene groups mention may be made of isophoronediamine, 4,4′-methylene-bis(2-methylcyclohexylamine) (MACM), 4,4′-methylene-bis-cyclohexylamine (PACM) and mixtures thereof.

In certain embodiments, the aliphatic diamine can be derived from renewable materials. Notable non-limiting examples of such diamines are for instance 1,9-nonanediamine, 1,10-decanediamine which can be derived from castor oil and 1,12-dodecanediamine.

The dicarboxylic acid component is an aromatic dicarboxylic acid. Suitable aromatic dicarboxylic acids include, but are not limited to, terephthalic acid, isophthalic acid; naphthalenedicarboxylic acids (e.g. naphthalene-2,6-dicarboxylic acid); 4,4′-bibenzoic acid; 2,5-pyridinedicarboxylic acid; 2,4-pyridinedicarboxylic acid; 3,5-pyridinedicarboxylic acid; 2,2-bis(4-carboxyphenyl) propane; 2,2-bis(4-carboxyphenyl) hexafluoropropane; 2,2-bis(4-carboxyphenyl) ketone; 4,4′-bis(4-carboxyphenyl) sulfone; 2,2-bis(3-carboxyphenyl) propane; 2,2-bis(3-carboxyphenyl) hexafluoropropane; 2,2-bis(3-carboxyphenyl) ketone and bis(3-carboxyphenoxy)benzene.

Polyamide PA2 is formed from the polycondensation of a diamine component and a dicarboxylic acid component as defined above. The amount of —NH₂ from the diamine component and the amount of —COOH [symbol] ratio amine/acid is from 0.9 to 1.1, preferentially 0.95 to 1.05, even more preferentially from 0.98 to 1.02.

Polyamide PA2 can be a co-polyamide, that is it may derive from the polycondensation reaction of one or more than one lactam or aminoacid and/or one or more than one diamine component and/or one or more than one dicarboxylic acid component with the proviso that the diamine component is a diamine having 9 carbon atoms or more and that the dicrboxylic acid component comprises at least one aromatic dicarboxylic acid.

Typically, when polyamide PA2 is formed from the polycondensation of a diamine component and a dicarboxylic acid component it has a C/NHCO ratio of 7.5 or more. The C/NHCO ratio can be calculated as detailed above for polyamide PA1.

Polyamide PA2 may conveniently be selected from the group consisting of PA9T, PA9T/8MeT, PA10T, PA9T/TMDT, PA10/TMDT, PA 10T/10I, PA9T/9I, PA 11T, PA 12T, PA 9T/11T, PA 9T/12T, PA 10T/11T, PA 10T/12T, PA 11T/12T.

Polyamide PA2 may have a melting temperature of 200-320° C., preferably 220-300° C. Melting temperature is typically measured at 2^{nd} heat scan by Differential Scanning calorimetry (DSC) according to ASTM D3418 using a heating and cooling rate of 20° C./min.

Layer (CL) may comprise one or more than one polyamide PA2.

In an advantageous embodiment, the polyamide PA2 is the sole polymer in Layer (CL).

Layer (CL) comprises continuous reinforcing fibers impregnated with the poly(arylene sulfide) polymer as detailed hereafter. As used herein, the expression “continuous reinforcing fiber” refers to a fiber having a length of at least 5 mm. The length of the fiber corresponds to the longest dimension of the fiber.

In some embodiments, the continuous reinforcing fiber has a length, in the longest dimension, of at least 1 cm, at least 25 cm or at least 50 cm. The length of the continuous reinforcing fiber is dependent on the shape and size of the finished part.

The continuous reinforcing fiber is selected from the group consisting of glass fiber, carbon fibers, aluminum fiber, metallic fibers, ceramic fiber titanium fiber, magnesium fiber, boron carbide fibers, rock wool fiber, steep fiber, aramid fiber and natural fiber (e.g. cotton, linen and wood). Preferably the continuous reinforcing fiber is selected from the group consisting of glass fiber, carbon fiber, aramid fiber, and ceramic fiber. Advantageously the continuous reinforcing fiber is carbon fiber.

In some embodiments, Layer (CL) may include one or more additional continuous reinforcing fibers, each distinct in compositions and as described above.

Overall, the continuous reinforcing fibers constitute at least 5.0% of the total volume of Layer (CL). Typically the continuous reinforcing fibers constitute at least 10.0%, at least 15.0%, at least 20.0%, at least 25.0%, even at leas 30.0% of the total volume of Layer (CL). The continuous reinforcing fiber are no more than 80.0%, no more than 75.0%, even no more than 70.0% of the total volume of Layer (CL). The continuous reinforcing fibers may conveniently represent from 20.0% to 75.0%, from 25.0% to 70.0%, from 25.0% to 65.0% and even from 30.0% to 60.0% of the total volume of Layer (CL). The polymer matrix represents the remainder of the volume of Layer (CL).

The continuous reinforcing fibers in Layer (CL) are generally aligned along a single direction. Generally aligned fibers are oriented such that at least 70%, at least 80%, at least 90% or at least 95% of the fibers have a direction that is within 30 degrees, within 25 degrees, within 20 degrees, within 15 degrees, or within 10 degrees along the direction of the other fibers.

In certain embodiments the continuous reinforcing fibers in Layer (CL) may be arranged at an angle the ones with respect to the others. The continuous reinforcing fibers might be arranged as a woven fabric or a layered fabric of any combination of one or more.

Layer (CL) can be fabricated by methods well known in the art. In genera the method of fabrication includes a step of impregnation of the continuous reinforcing fibers with a polyamide PA2, and subsequent cooling or drying to form a Layer (CL).

Impregnation of the continuous reinforcing fibers with a polyamide PA2 may take place by means of a melt impregnation process, which include contacting the continuous reinforcing fibers with a melt of the polyamide polymer. Subsequent to melt impregnation, the impregnated continuous reinforcing fibers are cooled to form a solid composite.

Alternatively, impregnation may take place by means of a solution or a slurry process. In a solution process, a solution is formed by dissolving the polyamide polymer in a liquid medium. The solution is coated onto a surface of the continuous reinforcing fibers, for example, by passing the fiber through a bath of the solution. Subsequently, the coated fibers are the heated and consolidated. In a slurry process, the continuous fibers are impregnated with particles of the polymer, for example, by passing the fibers through a suspension of the particles in a liquid or a fluidized bed of the particles. Subsequently, the fibers containing the polymer particles are heated and consolidated.

When more than one Layer (CL) is present, each Layer (CL) may comprise the same or a different polyamide PA2, typically the same polyamide PA2.

Layer (CL) has a thickness which is usually between 100 microns and 500 microns. The thickness is adapted to provide multilayer structures which can be easily shaped to provide an article, such as a vessel.

### The Multilayer Structure

The multilayer structure comprises at least one Layer (BL) and at least one Layer (CL) which is in contact with the at least one Layer (BL) as defined above.

The multilayer structure can comprise up to ten Layers (BL) and up to ten or even more than ten Layers (CL).

The multilayer structure does not comprise a binder or adhesive layer between Layer (BL) and Layer (CL).

The multilayer structure can include more Layers (BL) than Layers (CL) or vice versa. Typically, the multilayer structure does not comprise alternating Layers (BL) and Layers (CL).

Advantageously, the multilayer structure comprises one, two, three, four, five, six, seven, eight, nine or ten Layers (BL) and one, two, three, four, five, ten, 50, 100 or even more Layers (CL), such as 200 or 300.

In one embodiment, the multilayer structure comprises a single Layer (BL) and several Layers (CL).

In one aspect of this embodiment, when more Layers (CL) are present, they have the same composition. Layers (CL) may be 2, 3, 5, 10, 50 and even 100, 200 or 300.

In an embodiment of the invention Layer (BL) comprises a polyamide PA1 with a C/NHCO ratio of 6.5 or less and Layer (CL) comprises a polyamide PA2 with a C/NHCO ratio which is at least 20% greater than the C/NHCO ratio of polyamide PA1. Preferably, Layer (BL) comprises a polyamide PA with a C/NHCO ratio of 6.0 or less and Layer (CL) comprises a polyamide PA2 with a C/NHCO ratio which is at least 20% greater than the C/NHCO ratio of polyamide PA1.

Despite the difference in the C/NHCO ratio between PA1 and PA2, the multilayer structure of the invention surprisingly exhibits an excellent interphase between PA1 and PA2, with no defects observed in RX tomography.

The multilayer structure of the invention may for instance comprise the following:
a Layer (BL) comprising a polyamide PA1 which is selected from the group consisting of PA6, PA46, PA56, PA MXD6, PA PXD6, PA MXD6/MXDI, PA MXD6/PXD6, their copolymers and their blends and a Layer (CL) comprising a polyamide PA2 which is selected from the group consisting of PA9T, PA9T/8MeT, PA10T, PA10/TMDT, PA 10T/10I, PA9T/9I, PA 11T, PA 12T, PA 9T/10T, PA 9T/11T, PA 9T/12T, PA 10T/11T, PA 10T/12T, PA 11T/12T, their copolymers and their blends; or alternatively
a Layer (BL) comprising a polyamide PA1 which is selected from the group consisting of PA6, PA46, PA56, PA MXD6, PA PXD6, PA MXD6/MXDI, PA MXD6/PXD6, their copolymers and their blends and a Layer (CL) comprising a polyamide PA2 which is selected from the group consisting of PA9T, PA9T/8MeT, PA10T, PA10/TMDT, PA 10T/10I, PA9T/9I, their copolymers and their blends.

The multilayer structure of the invention may alternatively comprise the following:
a Layer (BL) comprising a polyamide PA1 which has a melting temperature of 180 to 300° C. and a Layer (CL) comprising a polyamide PA2 which has a melting temperature of 200 to 320° C.; or
a Layer (BL) comprising a polyamide PA1 which has a C/NHCO ratio of 6.5 or less, preferably of 6.5 to 5.0, and a Layer (CL) comprising a polyamide PA2 which has a C/NHCO ratio of at least 7.5.

In some embodiments, the multilayer structure may comprise additional layers in contact with Layer (CL) on the opposite side of Layer (BL). Said additional layers may or may not comprise reinforcing fibers. The additional layers may or may not comprise a polyamide polymer.

The multilayer structure of the invention may be manufactured according to any method known in the art.

In an embodiment of the invention Layer (BL) and Layer (CL) are manufactured separately and are subsequently laminated together. Heat is generally applied to join together Layer (BL) and Layer (CL).

### The Article

A further object of the invention is an article for the storage and/or transportation of a gas, comprising the multilayer structure as defined above. Notable non-limiting examples of articles are hoses, pipes, tubes, joints, tanks, reservoirs or, in general, vessels.

Of these, the multilayer structure of the present invention is suitable for use as a hose for compressed gas, in particular hydrogen. The hose for compressed hydrogen is used as a hose for charging a fuel-cell vehicle or the like with hydrogen from a hydrogen station. Since the hose for compressed hydrogen is subject to repeated temperature changes (heat cycles) from −40° C. or lower to 90° C. or higher due to charging and discharging of high-pressure hydrogen, it is required to have high heat cycle resistance as well as hydrogen barrier.

The hose for high-pressure hydrogen is a hose comprising the multilayer structure of the first object, wherein Layer (BL) is in contact with the compressed gas and layer (CL) represents the outside of the hose.

The inventive multilayer structure is characterized by high thermal resistance and a good hydrogen barrier. These features make the multilayer structure particularly well adapted for the use in vessels for storing gasses such as hydrogen under pressure.

A further object of the invention is a vessel for the storage or transport of a gas, comprising the multilayer structure as defined above.

The term “vessel” is used herein to refer to a hollow container. The vessel of the invention is in particular a hollow container for containing a gas, preferably a pressurized or compressed gas.

Layer (BL) represents the internal layer of the vessel which is in contact with the gas to be transported or stored, hereinafter referred to as “liner”. Layer (CL) represents the external layer of the vessel.

The vessel is preferably a pressure vessel, that is a vessel suitable for the storage and transport of a gas under pressure.

The vessel, or preferably the pressure vessel, comprises a hollow body and at least one boss. A boss is known by a person skilled in the art and it refers to the opening in which a closure is attached which allows flow of gas or fluid in and out the vessel. A boss is usually made of metal.

The hollow body may have any shape suitable for the storage of a gas, in particular of a gas under pressure.

In certain conventional embodiments, the vessel has a cylindrical shape and a boss is placed at the end. Often, a vessel has two bosses at each end of the cylindrical shape.

The shape of the hollow body is determined by the desired use. It is usually but not exclusively cylindrical with a diameter of between 10.0 cm and 1.0 m. The diameter may be at least 15.0 cm or more.

The length of the hollow body also depends on the end use and may for example be between 50.0 cm and up to lengths as large as 10.0 m. These higher lengths are usually employed for gas transport. As an example, for vessels in trucks the length is usually between 1.0 m and 3.0 m.

The vessel of the invention may have an internal volume between 3.5 dm³ and 5.0 m³, even from 5.0 dm³ to 1.0 m³. The internal volume of the vessel may be at least 10.0 dm³, even at least 15.0 dm³. The internal volume may be up to 1.0 m³, even up to 0.5 m³.

The vessel comprises a hollow body comprising from the inside to the outside of the vessel: at least one Layer (BL), or liner, as defined above, and at least one structural composite layer, which is Layer (CL) as definec above, in contact with the at least one Layer (BL). Layer (BL) is in contact with the gas contained in the vessel.

The liner intends to provide a barrier between the fluid or gas and the Layer (CL), preventing leaks. In general, Layer (CL) is provided around the liner to provide mechanical properties, such as burst pressure resistance.

The vessel may be prepared according to any method known in the art.

For instance, the liner may be prepared by blow molding, tube extrusion, injection molding and welding and/or roto-molding. Layer (CL) may then be applied on the outer surface of the liner by winding a tape comprising continuous reinforcing fibers and a polyamide polymer PA2 around the hollow body made of the liner.

Other manufacturing processes as known in the art for the manufacture of pressure vessels can be used for making the inventive vessel.

Accordingly, the invention also relates to a process for preparing a vessel comprising the following steps:
a. providing a Layer (BL) in the form of a hollow body;
b. providing a Layer (CL) in the form of a continuous tape;
c. winding the tape around the liner while consolidating the tape by heat;
d. cooling the body obtained at the end of step c. to become solid.

The term “tape” is understood herein to refer to an elongated body having a longitudinal direction, a width, a thickness and a cross-sectional aspect ratio, i.e. the ratio of thickness to width. Said cross-section is defined as substantially perpendicular to the longitudinal direction of the tape. The longitudinal direction or machine direction of the tape essentially corresponds to the orientation of the endless fibers. The length dimension of a tape is not particularly limited. The length may exceed 10 km and the tape. Nevertheless said tape can for convenience reasons be manufactured to smaller sizes, according to the requirements of the envisioned applications.

Consolidation is performed preferably by heat, such as provided by a laser, as for example an infrared laser, or heating elements such as an oven.

The vessel according to the invention exhibits a nominal pressure of at least 2.5 MPa, typically at least 20.0 MPa, even at least 30.0 MPa. The nominal pressure may be up to 70.0 MPa, 100 MPa, even 150.00 MPa and more. Advantageously, the vessel of the invention has a nominal pressure of 20.0 to 70.0 MPa.

A burst pressure of at least 157.5 MPa may be reached for the storage of hydrogen gas with a vessel according to the invention. Vessels for the storage of compressed hydrogen typically require nominal pressures of 35.0 MPa or 70.0 MPa. Burst pressures, measured according to ECE R134, are typically up to 78.8 MPa and 157.5 MPa, respectively.

The inventive multilayer structure is characterized by a good hydrogen barrier and mechanical properties both at high and low temperatures. The inventive multilayer structure further exhibits limited water pick-up.

A further object of the invention is a compressed gas contained in a vessel comprising the multilayer structure of the first object, wherein Layer (BL) is in contact with the compressed gas. The gas is advantageously selected from the group consisting of hydrogen, oxygen, nitrogen, argon, helium, methane, propane, compressed natural gas, CO₂ and ammonia.

The gas is typically at a pressure of at least 5.0 MPa, preferably at least 10.0 MPa. Depending on the gas, the pressure may be up to 150.0 MPa.

A further object of the invention is a vehicle comprising the vessel or the compressed gas contained in the vessel.

The vehicle may be a car, a truck, a train, a ship, an urban mobility vehicle, an airplane, a helicopter or any other vehicle that could be powered using the conversion of a gas into energy by any means.

The embodiments above are intended to be illustrative and not limiting. Additional embodiments are within the inventive concepts. In addition, embodiments, those skilled in the art will recognize that changes can be made in form and detail without departing from the spirit and scope of the invention.

### EXAMPLES

### Materials

PA1-1: MX Nylon S6007, a PA MXD6 nylon polymer, commercially available from Mitsubishi Gas Chemical Co

PA1-2: Ixef® BXT 2000 an impact modified PA MXD6/MXDI copolymer commercially available from Solvay Specialty Polymer USA, LLC

PA1-3: Amodel® 1004 a PA 6T/6I/66 copolymer commercially available from Solvay Specialty Polymer USA, LLC

PA1-4: Amodel® ET 1000 HS NT an impact modified PA 6T/6I/66 copolymer, commercially available from Solvay Specialty Polymer USA, LLC

PA2-1: Genestar® GC98018, a PA 9T/8MeT copolymer, commercially available from Kuraray

PA12 is Grilamid® L25NZ an impact modified PA12 commercially available from EMS Chemie

### Tensile Testing

Tensile properties were measured according to ISO 527-2 using samples meeting the requirements of ISO 1BA at a test speed of 5 mm/min and at the indicated temperature. The ISO 1BA samples were annealed at a temperature of 20° C. above their glass transition temperature for a period of 2 h to ensure full crystallinity prior to tensile testing.

### H₂ Permeation Coefficient Determination

Samples for hydrogen permeation testing were prepared as follows. Polymers were dried overnight at 107° C. in a desiccant drying oven with a 40° C. dew point to ensure material was dry prior to injection molding into plates. Material was injection molded into 10 cm×10 cm×0.32 cm plates using a 250 ton Sumitomo SE 250 EV-A HD all electric injection molding machine, following the polymer suppliers recommended injection molding processing guidelines. The molding machine was fitted with a 45 mm screw size with a maximum screw speed of 250 rpm with a maximum shot the maximum injection pressure was 215 MPa. The plates were annealed at a temperature of 20° C. above their glass transition temperatures for a period of 2 h to ensure full crystallinity prior to hydrogen permeation testing.

Samples were mounted in a sealed chamber and a check was made to ensure that the chamber was leak tight by applying hydrogen at 1 MPa on the feed side. Subsequently the chamber was conditioned at the temperature of testing. On the feed side H₂ was fed at 1 MPa. On the permeate side, synthetic air was fed at a controlled throughput and H₂ was measured using a calibrated Inficon Sentrac H₂ Leak Detector, until a stable value for H₂ was obtained to assure a stationary regime.

The permeation coefficient was calculated taking into account the thickness of the sample, the exposed surface, the flow rate of the carrier gas and the pressure.

The results are shown in Table 1.

TABLE 1

| | | | | | H₂ Permeation |
|---|---|---|---|---|---|
| | | | | | Coefficient |
| | | Thermal | | Strain @ | @ 85° C. |
| | | properties | | Break | Ncm³ · |
| | C/NHCO | Tm | Tg | @−40° C. | mm/m² · d · |
| | ratio | (° C.) | (° C.) | % | bar |
| PA1-1 | 6.0 | 240 | 85 | 5 | 87 |
| PA1-2 | 6.0 | 240 | 85 | 6 | 164 |
| PA1-3 | 5.9 | 310 | 125 | 6 | 86 |
| PA1-4 | 5.9 | 310 | 125 | 8 | 203 |
| PA2-1 | 7.5 | 264 | 115 | 15 | 200 |
| PA12 | 11 | 178 | 49 | 17 | 2620 |

The data in Table 1 show a good tradeoff between hydrogen permeation and mechanical properties. The combination of the properties above allows the design of thinner liners without compromising the mechanical

### Preparation of Multilayer Structures

Composite samples of 4 mm thickness were prepared starting from a unidirectional PA 2-1/carbon fiber tape using polymer PA 2-1 and 60% volume fraction of carbon fibers Hyosung 2550, 12 k (hereinafter CF), in a press at 320° C., applying a pressure of 0.5 MPa for 5 minutes and 2 MPa for 1 minute.

Samples of PA 1-1 sheets and PA 1-2 sheets (as described above) as Layer (BL) were co-consolidated with the PA 2-1/CF composite samples (as Layer (CL)) in a press with limited contact time (to simulate conditions of a winding process) under the following operating conditions: preheating of the mold at 285° C.; contact time of 3 minutes, contact pressure of 0.7 MPa.

At the end of the consolidation step samples were analyzed by X-ray tomography using a 150 KV source and a focal spot of 20μ. The results are reported in Table 2.

TABLE 2

| Structure | |
|---|---|
| (BL)//(CL) | |
| PA 1-1// PA 2-1 + CF | no defects at interface |
| PA 1-2 //PA 2-1 + CF | no defects at interface |

The interface between Layer (BL) and Layers (CL) in the multilayer structures defined above showed no defects regardless of the different nature of the polyamide polymers in the layers.

1. A multilayer structure comprising at least one barrier layer, and at least one composite layer, in contact with the at least one barrier layer wherein:
Layer (BL) comprises a polyamide polymer PA1; and
Layer (CL) comprises continuous reinforcing fibers and a polyamide polymer PA2,
wherein: polyamide polymer PA1 is selected from the group consisting of the polyamides comprising recurring units deriving from the polycondensation of i) caprolactam; and/or ii) at least one diamine component having 4 to 8 carbon atoms and at least one dicarboxylic acid component having 8 carbon atoms or less;
polyamide polymer PA2 is selected from the group consisting of the polyamides consisting of recurring units deriving from the polycondensation of at least one diamine component, said diamine component having at least 9 carbon atoms, at least one aromatic dicarboxylic acid component and optionally one or more components selected from the group consisting of lactams, aminoacids and aliphatic dicarboxylic acids.

2. The multilayer structure of claim 1 in which polyamide PA1 has a C/NHCO ratio of 6.5 or less.

3. The multilayer structure of claim 1 in which polyamide PA2 has a C/NHCO ratio which is at least 20% greater than the C/NHCO ratio of polyamide PA1.

4. The multilayer structure of claim 1 in which polyamide PA1 is selected from the group consisting of PA6, PA46, PA56, PA MXD6, PA PXD6, PA MXD6/MXDI, PA MXD6/PXD6, their copolymers and their blends.

5. The multilayer structure of claim 1 in which polyamide PA2 is selected from the group consisting of PA9T, PA9T/8MeT, PA10T, PA10/TMDT, PA 10T/10I, PA9T/9I, PA 11T, PA 12T, PA 9T/10T, PA 9T/11T, PA 9T/12T, PA 10T/11T, PA 10T/12T, PA 11T/12T, their copolymers and their blends.

6. The multilayer structure of claim 1 in which polyamide PA1 has a melting temperature of 180 to 300° C. and polyamide PA2 has a melting temperature of 200 to 320° C.

7. The multilayer structure of claim 1 in which the continuous reinforcing fibers have a length of at least 5 mm.

8. The multilayer structure of claim 1 in which the continuous reinforcing fibers are selected from the group consisting of glass fiber, carbon fiber, aramid fiber, and ceramic fiber.

9. The multilayer structure of claim 1 in which the continuous reinforcing fibers are in an amount of 15.0% to 80.0% with respect to the total volume of Layer (CL).

10. The multilayer structure of claim 1 which consists of one or more Layers (BL) and one or more Layers (CL).

11. An article for storing and/or transporting a gas comprising the multilayer structure of claim 1.

12. The article of claim 11 in the form of a vessel or a hose.

13. The vessel of claim 12 which is in the shape of a hollow body which has one or more of the following:
a diameter of 10.0 to 1.0 m;
a length of 50.0 cm to 10.0 m; and
an internal volume of 3.5 dm³ to 5.0 m³.

14. A compressed gas contained in the vessel of claim 12, wherein the compressed gas is in contact with Layer (BL).

15. The compressed gas of claim 14 which is selected from the group consisting of hydrogen, oxygen, nitrogen, argon, helium, methane, propane, compressed natural gas, CO₂, ammonia.

16. A vehicle comprising the vessel of claim 12 or a compressed gas contained in the vessel.

17. A method for transporting a compressed gas comprising flowing the compressed gas through the hose of claim 12.

18. A method comprising storing or transporting a compressed gas with the vessel of claim 12.
